(19) United States
(12) Patent Application Publication
(10) Pub. No.: US 2026/0328457 A1
(43) Pub. Date: Oct. 22, 2026

(54) CYLINDER FOR SHAVED ICE MACHINE

(71) Applicant: Ningbo Jiuju Intelligent Technology Co., Ltd., Ningbo (CN)

(72) Inventors: Qifeng Luo, Ningbo (CN); Wanquan Liu, Ningbo (CN)

(21) Appl. No.: 19/695,206

(22) Filed: Jun. 2, 2026

(30) Foreign Application Priority Data
Apr. 17, 2026 (CN) 202620521972.3

(51) Int. Cl. F25C 5/12; A23G 9/12; A23G 9/22; A23G 9/28

(52) U.S. Cl. CPC F25C 5/12; A23G 9/12; A23G 9/224; A23G 9/28

(57) ABSTRACT

Provided is a cylinder for a shaved ice machine, including a cylinder. A discharge hole is provided on one side of the cylinder. A material baffle is disposed at a top of the cylinder and close to the discharge hole. The material baffle is tilted relative to the top of the cylinder, so that the material baffle can effectively avoid a material accumulation problem in the cylinder, and reduce a frequency of disassembling the cylinder for manual cleaning, thereby improving user experience.

### TECHNICAL FIELD

The present disclosure relates to the field of shaved ice machines, and in particular to a cylinder for a shaved ice machine.

### BACKGROUND

A shaved ice machine is an electrical appliance used to mix and agitate fruits, vegetables, ice blocks, yogurt, and other food ingredients so as to prepare fine, smooth, and cold drinks. However, because prepared shaved ice is mostly a semi-solid product with high consistency, materials are easily adhered to an inner wall of a cylinder. Although an agitator is disposed in the cylinder for continuous agitation to prevent adhesion, shaved ice that fails to be discharged from a discharge hole is gradually accumulated in an area above the discharge hole and at an agitation tail end on the inner wall of the cylinder. Finally, these residues cannot be removed by agitating or pouring, and the whole cylinder has to be disassembled for manual cleaning. This process is not only cumbersome, but also time-consuming and labor-intensive.

### SUMMARY

In view of defects existing in a conventional cylinder for a shaved ice machine, a technical problem to be solved in the present disclosure is to provide a cylinder for a shaved ice machine, which can effectively avoid a material accumulation problem in the cylinder, and reduce a frequency of disassembling the cylinder for manual cleaning.

In order to achieve the foregoing objective, according to one aspect of the present disclosure, the present disclosure is achieved through the following technical measures: A cylinder for a shaved ice machine includes a cylinder, where a discharge hole is provided on one side of the cylinder, a material baffle is disposed at a top of the cylinder and close to the discharge hole, and the material baffle is tilted relative to the top of the cylinder.

Further, the material baffle and a housing of the cylinder are integrally formed.

Further, the material baffle includes a transverse baffle and a vertical baffle, the transverse baffle is perpendicular to an agitator shaft, and the vertical baffle is disposed in an outer circumferential direction of the agitator shaft, and is located at a tail end of an agitator rotation direction.

Further, an angle exists between the vertical baffle and the agitator shaft, and the vertical baffle gradually approaches the agitator shaft in a material advance direction.

Further, the transverse baffle and the vertical baffle are in circular arc transition, and the transverse baffle, the vertical baffle, and other side walls of the cylinder are in circular arc transition.

Compared with the prior art, the present disclosure has the following advantages: According to the cylinder for a shaved ice machine, the transverse baffle can prevent materials that fail to be discharged from the discharge hole from piling up on the top of the cylinder close to the discharge hole, and the vertical baffle can prevent the materials from piling up at agitation dead angles, thereby reducing a frequency of disassembling the cylinder for manual cleaning, and improving user experience.

### BRIEF DESCRIPTION OF THE DRAWINGS

Drawings, which form a part of the present disclosure and are provided for further understanding of the present disclosure, show the preferred embodiments of the present disclosure, and explain the principle of the present disclosure together with the description, but not by way of limitation with regard to the present disclosure. In the drawings,

FIG. 1 is a structure diagram of a cylinder for a shaved ice machine according to the present disclosure.

Reference numerals in the drawings: 1: cylinder; 2: discharge hole; 3: transverse baffle; 4: vertical baffle; 5: material advance direction; and 6: agitator shaft.

### DETAILED DESCRIPTION OF THE EMBODIMENTS

The present disclosure is described in detail below with reference to the drawings in conjunction with the embodiments. It needs to be noted that the embodiments in the present disclosure and the features in the embodiments can be combined with each other without conflict.

In the description of the present disclosure, it needs to be understood that the indicative direction or position relations of the terms such as “center”, “upper”, “lower”, “left”, “right”, “vertical”, “horizontal”, “inside”, “outside”, “bottom”, and “top” are direction or position relations illustrated based on the drawings, just for facilitating the description of the present disclosure and simplifying the description, but not for indicating or hinting that the indicated device or element must be in a specific direction and is constructed and operated in the specific direction, the terms cannot be understood as the restriction of the present disclosure.

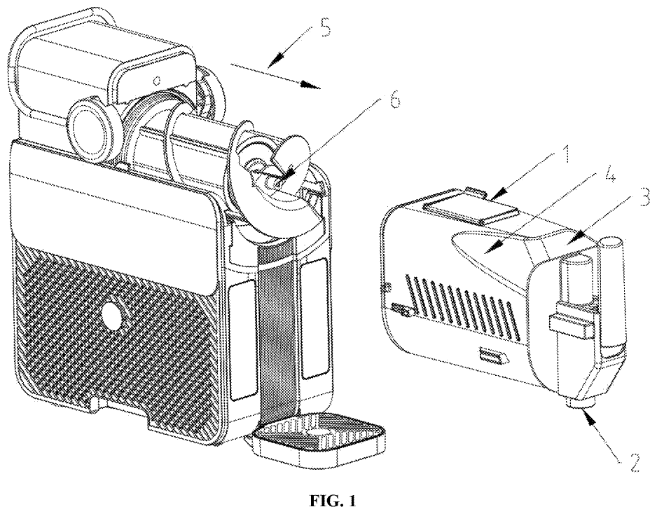

Referring to FIG. 1, a cylinder for a shaved ice machine provided in the present disclosure includes a cylinder 1. A discharge hole 2 is provided on one side of the cylinder 1. A material baffle is disposed at a top of the cylinder 1 and close to the discharge hole 2. The material baffle and a housing of the cylinder 1 are integrally formed. The material baffle is tilted relative to the top of the cylinder 1, including a transverse baffle 3 and a vertical baffle 4. The transverse baffle 3 and the vertical baffle 4 are in circular arc transition. The transverse baffle 3 is perpendicular to an agitator shaft 6. The vertical baffle 4 is disposed in an outer circumferential direction of the agitator shaft 6, and is located at a tail end of an agitator rotation direction. An angle exists between the vertical baffle 4 and the agitator shaft 6, and the vertical baffle 4 gradually approaches the shaft in a material advance direction 5. The transverse baffle 3, the vertical baffle 4, and other side walls of the cylinder 1 are in circular arc transition.

According to a cylinder for a shaved ice machine provided in the embodiment, when in use, the transverse baffle 3 can prevent materials that fail to be discharged from the discharge hole 2 from piling up on the top of the cylinder 1 close to the discharge hole 2, and the vertical baffle 4 can prevent the materials from piling up at agitation dead angles, so that a material accumulation problem in the cylinder 1 can be effectively avoided, thereby reducing a frequency of disassembling the cylinder 1 for manual cleaning, and improving user experience.

The foregoing descriptions are merely exemplary embodiments of the present disclosure, but are not intended to limit the present disclosure, and for the skill in the art, the present disclosure can be of various modifications and changes. Any modification, equivalent replacement, or improvement made without departing from the spirit and principle of the present disclosure shall fall within the protection scope of the present disclosure.

What is claimed is:

1. A cylinder for a shaved ice machine, comprising a cylinder (1), wherein a discharge hole (2) is provided on one side of the cylinder (1), a material baffle is disposed at a top of the cylinder (1) and close to the discharge hole (2), and the material baffle is tilted relative to the top of the cylinder (1).

2. The cylinder for a shaved ice machine according to claim 1, wherein the material baffle and a housing of the cylinder (1) are integrally formed.

3. The cylinder for a shaved ice machine according to claim 1, wherein the material baffle comprises a transverse baffle (3) and a vertical baffle (4), the transverse baffle (3) is perpendicular to an agitator shaft (6), and the vertical baffle (4) is disposed in an outer circumferential direction of the agitator shaft (6), and is located at a tail end of an agitator rotation direction.

4. The cylinder for a shaved ice machine according to claim 3, wherein an angle exists between the vertical baffle (4) and the agitator shaft (6), and the vertical baffle (4) gradually approaches the agitator shaft (6) in a material advance direction (5).

5. The cylinder for a shaved ice machine according to claim 3, wherein the transverse baffle (3) and the vertical baffle (4) are in circular arc transition, and the transverse baffle (3), the vertical baffle (4), and other side walls of the cylinder (1) are in circular arc transition.
